(19) United States
(12) Patent Application Publication
(10) Pub. No.: US 2007/0124229 A1
(43) Pub. Date: May 31, 2007

(54) Random drawing auction system and method based on entrance fee profit model

(76) Inventors: Young-Bae Ku, Gwanack-Gu (KR); Say-Hyung Kim, Gyunggi-Do (KR); Eun-Hee Nam, Seoul (KR)

Correspondence Address: CANTOR COLBURN, LLP, 55 GRIFFIN ROAD SOUTH, BLOOMFIELD, CT, 06002, US

(21) Appl. No.: 10/586,988

(22) PCT Filed: Oct. 14, 2004
(86) PCT No.: PCT/KR04/02626

§ 371 Date: Jul. 21, 2006

(30) Foreign Application Priority Data
Feb. 7, 2004 (KR) 10-2004-0008128

(51) Int. Cl. G06Q 40/00

(52) U.S. Cl. 705/37

(57) ABSTRACT

A random drawing auction system and method based on an entrance fee profit model are provided. In the random drawing auction system and method, information of an item to be auctioned is registered directly or through a seller. An entrance fee of the item is collected from each buyer wishing to bid for the item. A bidder offering a tender price closest to a reference contract price calculated using a random probability function is selected as a successful bidder after a bid for the item is terminated. The tender price offered by the successful bidder is collected from the successful bidder. The item is delivered to the successful bidder, and the collected tender price and an amount of money which is less than an open market selling price of the item in an accumulated entrance fee of the item is given to the seller as a sales payment for the item.

### TECHNICAL FIELD

The present invention relates to a random drawing auction system and method based on an entrance fee profit model. More particularly, the present invention relates to a random drawing auction system and method based on an entrance fee profit model, in which information of an item to be auctioned is registered directly or through a seller, an entrance fee of the item is collected from each buyer wishing to bid for the item, a bidder offering a tender price closest to a reference contract price calculated using a random probability function is selected as a successful bidder after a bid for the item is terminated, the tender price offered by the successful bidder is collected from the successful bidder, the item is delivered to the successful bidder, and the collected tender price and an amount of money which is less than an open market selling price of the item in an accumulated entrance fee of the item is given to the seller as a sales payment for the item.

### BACKGROUND ART

Recently, various kinds of electronic commerce using Internet have been introduced. Electronic commerce may be divided into a shopping mall type, a basic auction type, a reverse auction, a brokerage type, and a tender type.

In basic auction type electronic commerce, a seller puts an item up at auction through the Internet, and buyers offer diverse prices for the item. A buyer offering a highest price among the buyers is settled as a successful bidder, and a transaction is made.

Such basic auction is characterized by making a plurality of buyers to compete with one another and settling on a highest price. Accordingly, when the auction item is popular, a lot of buyers bid for the auction item, and a sales price may highly increase until the end of listing.

The basic auction is disadvantageous for buyers in that a seller can unfairly increase a bid to make a contract price higher than the seller's expected price. In this case, the basic auction cannot guarantee buyers a chance to purchase a desired item at a low price. Conversely, when a contract price is lower than an open market selling price, the basic auction cannot guarantee sellers an appropriate sales margin.

In a tender type auction, bidders pay an entrance fee and offer a tender price for an auction item. When a tender price is unique and lowest, it is determined as a contract price, and the item is knocked down to a bidder offering the unique and lowest tender price.

In such tender type auction, the total amount of entrance fees collected from bidders is given to a seller. Accordingly, even when the total amount of entrance fees is several times greater than an open market selling price of an item, the total amount is paid to the seller, and therefore, the seller may unfairly benefit. In addition, since a chance to purchase a very expensive item at a very low price is given to bidders, the tender type auction may provoke bidders to bid in a speculative manner.

Moreover, since a system operator in the tender type auction is usually a seller, the number of bids or the total amount of bid price of bidders is not restricted. As a result, the tender type auction may increase popular speculation, thereby giving rise to public criticism. In addition, since expensive items unsuitable to usual electronic commerce are auctioned, the tender type auction may be considered to deviate from the normal behavior of the electronic commerce.

Although the tender type auction has problems like stirring up the gambling spirit, promoting excessive and unfair benefit of a seller, and disturbing the order of electronic commerce, it has an advantage of ensuring a sales space for expensive articles and articles fundamentally having a small number of potential buyers.

### DISCLOSURE OF THE INVENTION

The present invention provides a random drawing auction system and method based on an entrance fee profit model, in which it is determined whether a buyer requesting permission to bid for an item is qualified for bidding in order to restrict speculative bidding, each of buyers permitted to bid sets a tender price for the item, a tender price closest to a reference contract price determined using a random probability function or close in a predetermined sequence to the reference contract price is selected after a bid for the item is terminated, a buyer having set the selected tender price is determined as a successful bidder, an amount of money that is less than an open market selling price of the item in the accumulation of initial entrance fees collected from all of the buyers in advance to the bid for the item and the tender price collected from the successful bidder are given to a seller as a sales payment for the item, and when a type of entrance fee is a variable type and an accumulated entrance fee of the item exceeds the open market selling price of the item, the surplus of the accumulated entrance fee is appropriately distributed and returned to the buyers after the bid is terminated.

According to an aspect of the present invention, there is provided a random drawing auction system based on an entrance fee profit model, including a database unit storing auction condition information including an open market selling price, auction quantity, auction duration, an initial entrance fee and an entrance fee type of an item auctioned through Internet, bid history information of a buyer wishing to purchase the item through the Internet, and bid details information of the item; an item registration unit allowing a seller to register auction condition information of an item or directly register the auction condition information and posting the item and the auction condition information to a web site when an auction start time of the registered item is encountered; a bid qualification determiner determining whether a buyer is qualified for bidding for an item based on the buyer's bid history information in response to the buyer's request for permission to bid for the item; a bid execution unit requesting the buyer to pay an initial entrance fee of an item when a buyer is determined as being qualified for bidding for the item, collecting an initial entrance fee of the item from the buyer, requesting the buyer to set a tender price for the item, and inputting the tender price; a bid terminator determining whether to terminate a bid for an item based on at least one among auction duration of the item, for which the bid is being executed by the bid execution unit, and an accumulated entrance fee resulting from the bid of each of buyers for the item; a successful bidder selector calculating a reference contract price using a minimum contract price and a maximum contract price of an item and a random number induced by a random probability function after a bid for the item is terminated, comparing the reference contract price with a tender price set by each of buyers, and selecting as a successful bidder a buyer that has set a tender price closest to the reference contract price or close in a predetermined sequence to the reference contract price; and a delivery/payment processor collecting a tender price set by a buyer selected as a successful bidder, performing a process to deliver an item to the successful bidder, and giving a sales payment to a seller of the item.

According to another aspect of the present invention, there is provided a random drawing auction method based on an entrance fee profit model, including (a) receiving auction condition information including an open market selling price, auction quantity, auction duration, an initial entrance fee and an entrance fee type of an item from a seller wishing to sell the item through Internet, registering the auction condition information in a database, and posting the item and the auction condition information when an auction start time of the item is encountered; (b) determining whether a buyer accessing through the Internet is qualified for bidding based on bid history information of the buyer in response to the buyer's request for permission to bid for the item, collecting an entrance fee of the item from the buyer when it is determined that the buyer is qualified, and requesting the buyer to set and input a tender price of the item; (c) determining whether to terminate the bid for the item based on at least one among the auction duration of the item and an accumulated entrance fee resulting from the bid of each of buyers for the item; (d) calculating a reference contract price using a minimum contract price and a maximum contract price of the item and a random number induced by a random probability function after the bid for the item is terminated, comparing the reference contract price with a tender price set by each of the buyers, and selecting as a successful bidder a buyer that has set a tender price closest to the reference contract price or close in a predetermined sequence to the reference contract price; and (e) collecting the tender price set by the buyer selected as the successful bidder, performing a process to deliver the item to the successful bidder, and giving a sales payment to the seller of the item.

### BRIEF DESCRIPTION OF THE DRAWINGS

FIG. 1 illustrates a schematic operating environment for a random drawing auction system based on an entrance fee profit model according to an embodiment of the present invention;

FIG. 2 is a functional block diagram of the random drawing auction system based on an entrance fee profit model according to the embodiment of the present invention;

FIGS. 3A through 3F illustrate examples of databases (DBs) managed by the random drawing auction system based on an entrance fee profit model according to the embodiment of the present invention;

FIG. 4 is a flowchart of a random drawing auction method based on an entrance fee profit model according to an embodiment of the present invention;

FIG. 5A is a flowchart of a procedure for refunding an entrance fee in the random drawing auction method based on an entrance fee profit model, according to the embodiment of the present invention; and

FIG. 5B is a flowchart of a procedure for selecting a successful bidder in the random drawing auction method based on an entrance fee profit model, according to the embodiment of the present invention.

### BEST MODE FOR CARRYING OUT THE INVENTION

Hereinafter, embodiments of the present invention will be described in detail with reference to the attached drawings.

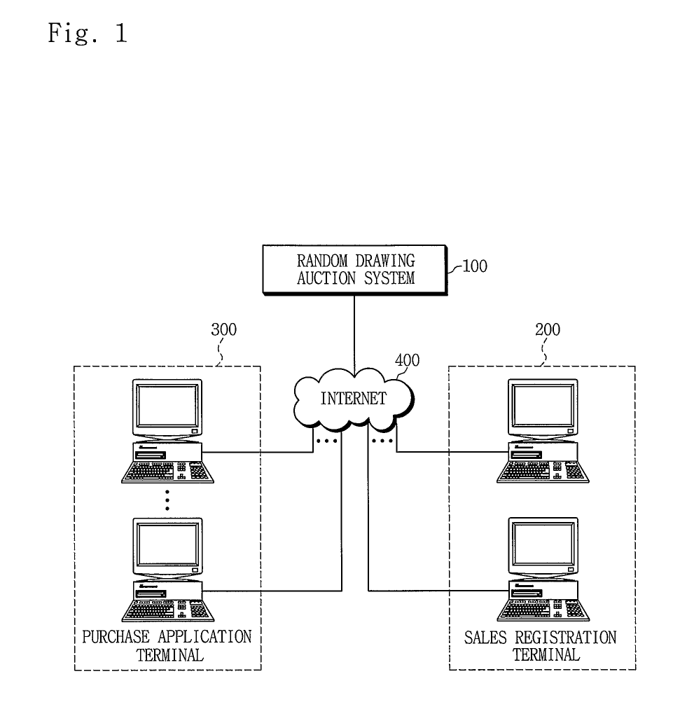

FIG. 1 illustrates a schematic operating environment for a random drawing auction system 100 based on an entrance fee profit model according to an embodiment of the present invention. Referring to FIG. 1, the random drawing auction system 100 based on an entrance fee profit model according to an embodiment of the present invention (hereinafter, referred to as the random drawing auction system 100 according to the present invention or the random drawing auction system 100) is connected with sellers' sales registration terminals 200 and buyers' purchase application terminals 300 through a computer communication network such as Internet 400. The sales registration terminals 200 and the purchase application terminals 300 may be personal computers, laptop computers, palm computers, Internet mobile phones, or Internet televisions. In an embodiment of the present invention, the sales registration terminals 200 and the purchase application terminals 300 are assumed to be personal computers.

The random drawing auction system 100 receives sales registrations for auction items from a sales registration terminal 200 through the Internet 400 and posts the auction item and auction conditions for each auction item (e.g., an open market selling price, auction quantity, auction duration, an initial entrance fee, and a type of entrance fee) to a website.

When buyers access the website of the random drawing auction system 100 through the Internet 400 using the purchase application terminals 300 and request permission to bid an item referring to the auction conditions for posted items, the random drawing auction system 100 determines whether the buyers are qualified for bidding for the item, requests bidders determined as being qualified to pay an initial entrance fee set for the item in advance to a bid, and requests bidders having prepaid the initial entrance fee to select a tender price.

After the bid for the item is terminated, the random drawing auction system 100 calculates a reference contract price of the item using a predetermined random probability function, selects a tender price closest to the reference contract price or close in a predetermined sequence to the reference contract price, and selects a bidder having set the selected tender price as a successful bidder.

Thereafter, the random drawing auction system 100 collects the selected tender price from the successful bidder and gives a seller of the item notice so that the seller delivers the item to the successful bidder. After the delivery of the item is completed, the random drawing auction system 100 gives a sales payment for the item to the seller.

When a type of entrance fee is a variable type, after the bid ends, the random drawing auction system 100 calculates the accumulation of entrance fees collected from the bidders, calculates a maximum payable bid price that can be paid as the sales payment for the item using the open market selling price and the auction quantity of the item, determines whether to refund the entrance fee based on the accumulation of the entrance fees and the maximum payable bid price, and refunds a certain amount of money to the bidders. The type of entrance fee may be a fixed type where an initial entrance fee set by a seller for an item is fixed and a variable type where the initial entrance fee varies with the accumulated entrance fees obtained after a bid ends and a total number of bidders.

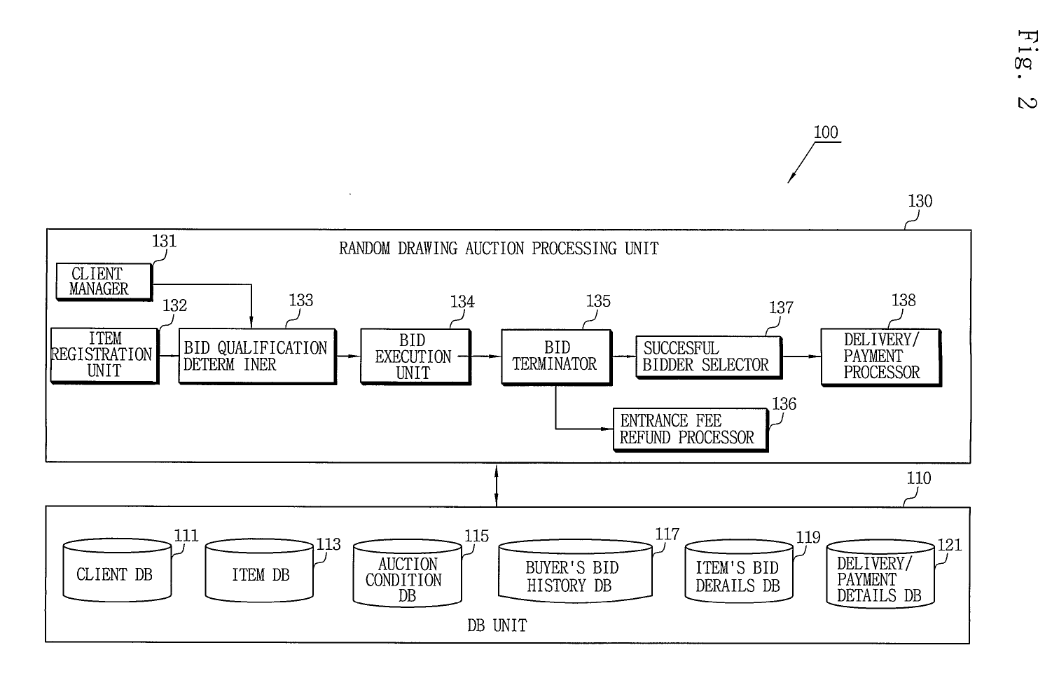

FIG. 2 is a functional block diagram of the random drawing auction system 100. Referring to FIG. 2, the random drawing auction system 100 includes a database (DB) unit 110 and a random drawing auction processing unit 130.

The DB unit 110 includes a client DB 111, an item DB 113, an auction condition DB 115, a buyer's bid history DB 117, an item's bid details DB 119, a delivery/payment details DB 121.

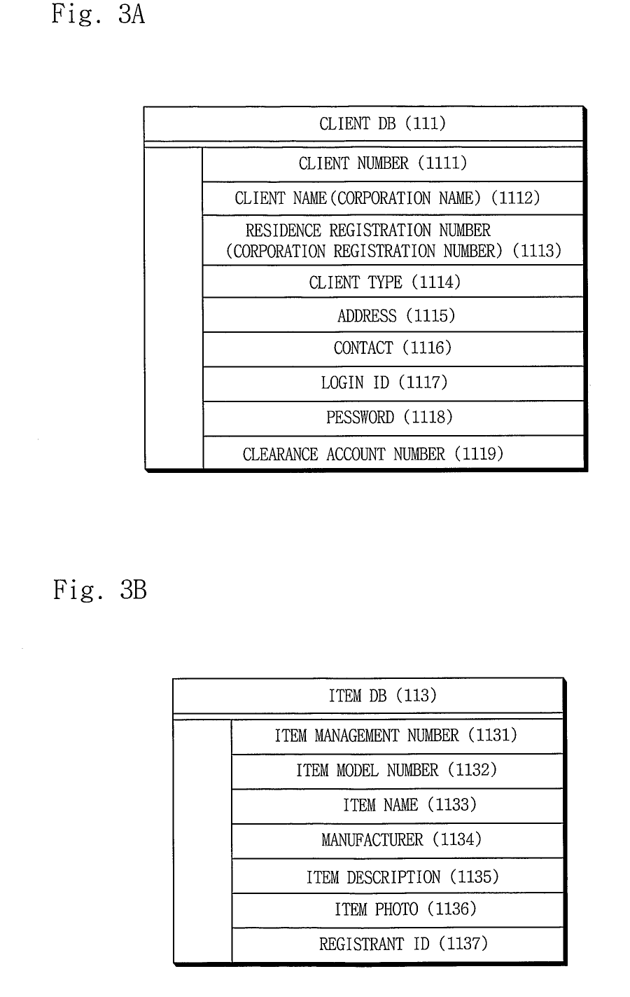

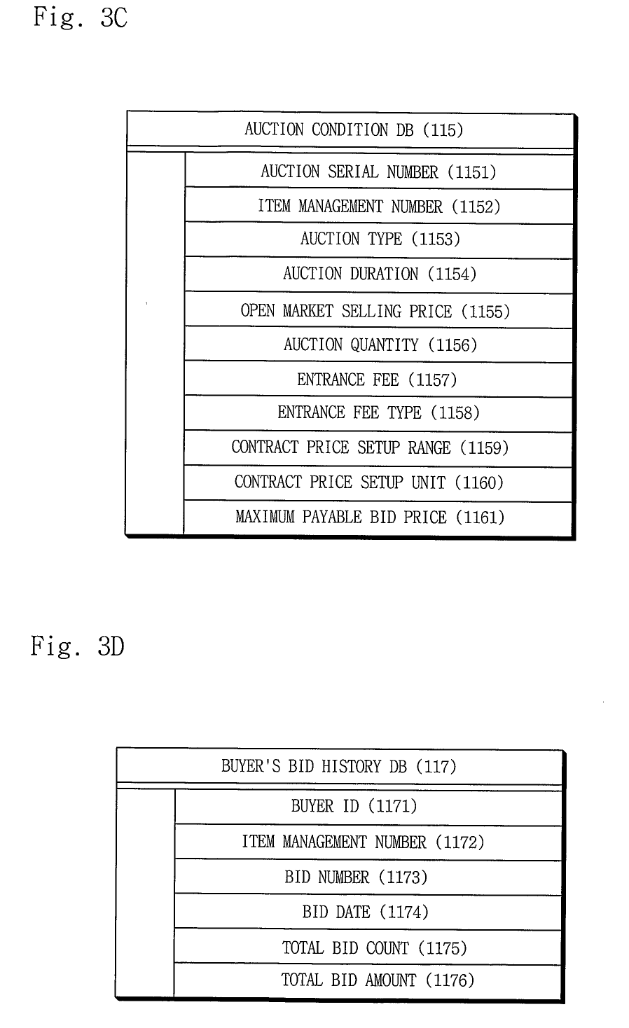

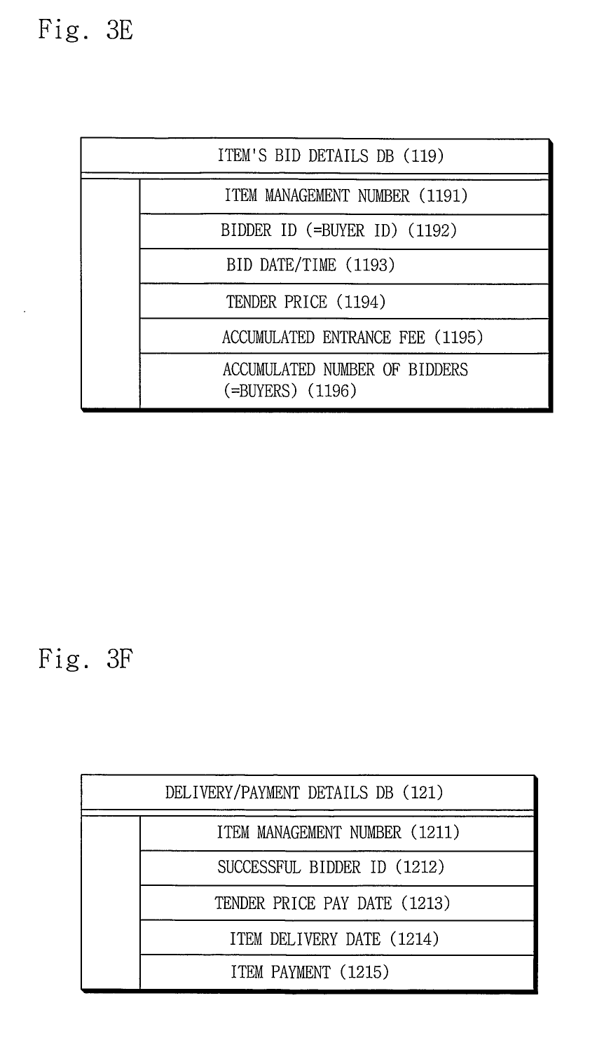

The client DB 111 stores and manages basic information of a seller or a buyer. Referring to FIG. 3A, the client DB 111 includes a client number field 1111, a client name (corporation name) field 1112, a residence registration number (corporation registration number) field 1113, a client type field 1114, an address field 1115, a contact field 1116, a login ID field 1117, a password field 1118, and a clearance account number field 1119. Information for discriminating a seller and a buyer is recorded in the client type field 1114. Information such as a home phone number, an office phone number, a mobile phone number, and/or an e-mail address is recorded in the contact field 1116.

The item DB 113 stores and manages basic information of an item registered by a seller to be auctioned. Referring to FIG. 3B, the item DB 113 includes an item management number field 1131, an item model number field 1132, an item name field 1133, a manufacturer field 1134, an item description field 1135, an item photo field 1136, and a registrant ID field 1137. The item description field 1135 contains various types of item information that will be helpful to a buyer selecting an item. Information for identifying a registrant of the item, e.g., a seller ID, may be recorded in the registrant ID field 1137. In addition, the item DB 113 may further include fields for recording other various types of information such as a provenance of the item, an optional item, and a delivery fee.

The auction condition DB 115 stores and manages information of auction conditions set for an item by a seller when the seller registers the item. Referring to FIG. 3C, the auction condition DB 115 includes an auction serial number field 1151, an item management number field 1152, an auction type field 1153, an auction duration field 1154, an open market selling price field 1155, an auction quantity field 1156, an entrance fee field 1157, an entrance fee type field 1158, a contract price setup range field 1159, a contract price setup unit field 1160, and a maximum payable bid price field 1161. Information for identifying an auction type (e.g., a normal type or a random drawing type) is recorded in the auction type field 1153. In the present invention, the random drawing type is used. Either a fixed type or a variable type is recorded in the entrance fee type field 1158. An initial entrance fee, a contract price setup range, and a contract price setup unit, which are suggested by a seller or the random drawing auction system 100, are recorded in the entrance fee field 1157, the contract price setup range field 1159, and the contract price setup unit 1160, respectively. The initial entrance fee, the contract price setup range, and the contract price setup unit for an item may be offered by a seller in accordance with the provision of the random drawing auction system 100. When a seller does not offer the initial entrance fee, the contract price setup range, and the contract price setup unit for an item, the random drawing auction system 100 can offer them taking account of an open market selling price (indicating a price obtained by adding a predetermined weight to a full price of the item) and auction quantity of the item. The maximum payable bid price field 1161 contains the amount of money (i.e., a maximum payable bid price) calculated by the random drawing auction system 100 using the open market selling price and the auction quantity of the item. For example, when the open market selling price of the item is 100,000 won and the auction quantity of the item is 2, “200,000 won” is recorded in the maximum payable bid price field 1161. The amount of money recorded in the maximum payable bid price field 1161 is used as reference for the limit of a sale payment to be given to a seller.

The buyer's bid history DB 117 stores and manages information on a buyer's bid history. Referring to FIG. 3D, the buyer's bid history DB 117 includes a buyer ID field 1171, an item management number field 1172, a bid number field 1173, a bid date field 1174, a total bid count field 1175, and a total bid amount field 1176. The total bid count field 1175 contains a total number of bids performed by a buyer for a certain item or during a predetermined period of time (e.g., for a month). The total bid amount field 1176 contains a total amount of bid prices placed by the buyer for the item or during the predetermined period of time. Information recorded in the total bid count field 1175 and the total bid amount field 1176 is used to suppress the buyer's excessive bidding behavior. The buyer's bid history DB 117 may include only one among the total bid count field 1175 and the total bid amount field 1176.

The item's bid details DB 119 stores and manages bid details of an item during auction duration. Referring to FIG. 3E, the item's bid details DB 119 includes an item management number field 1191, a bidder ID (or buyer ID) field 1192, a bid date/time field 1193, a tender price field 1194, an accumulated entrance fee field 1195, and an accumulated number of bidders (or buyers) field 1196. The accumulated entrance fee field 1195 contains the accumulation of entrance fees prepaid by buyers to bid, i.e., bidders, for an item. The accumulated number of bidders field 1196 contains a total number of bidders bidding for the item. The item's bid details DB 119 may further include a field containing a payment scheme used by a bidder to prepay the entrance fee.

The delivery/payment details DB 121 stores and manages a delivery result and payment details for an item knocked down to a successful bidder. Referring to FIG. 3F, the delivery/payment details DB 121 includes an item management number field 1211, a successful bidder (or buyer) ID 1212, a tender price pay date field 1213, an item delivery date field 1214, and an item payment field 1215.

The fields included in the DBs 111, 113, 115, 117, 119, and 121 are not restricted to those described above, and a field may be added or eliminated by an operator of the random drawing auction system 100 when necessary. In addition, the random drawing auction system 100 can construct and manage a DB in addition to the above-described DBs 111, 113, 115, 117, 119, and 121 when necessary.

The random drawing auction processing unit 130 shown in FIG. 2 includes a client manager 131, an item registration unit 132, a bid qualification determiner 133, a bid execution unit 134, a bid terminator 135, an entrance fee refund processor 136, a successful bidder selector 137, and a delivery/payment processor 138.

The client manager 131 receives basic information from a seller wishing to sell an item using the random drawing auction system 100 online, receives basic information from a buyer wishing to buy the item provided by the seller, and registers the seller and the buyer in the client DB 111.

In addition, the client manager 131 provides a program (referred to as a sales registration program) allowing a seller to register information on an item to be auctioned to the random drawing auction system 100 through the Internet 400. Sellers can download the sales registration program to their sales registration terminals 200 and then directly register the item information in the random drawing auction system 100. In addition, sellers can register the item information in the random drawing auction system 100 under the connection to the random drawing auction system 100.

The item registration unit 132 receives basic information of an item and auction conditions for the item from a seller's sales registration terminal 200 through the Internet 400 and registers them in the item DB 113 and the auction condition DB 115.

When the auction conditions received from a seller do not include an initial entrance fee, a contract price setup range, and a contract price setup unit, the item registration unit 132 sets the initial entrance fee, the contract price setup range, and the contract price setup unit (e.g., 1 won) taking account into an open market selling price and auction quantity of the item before registering the auction conditions in the auction condition DB 115. Alternatively, when the auction conditions received from the seller include the initial entrance fee and the contract price setup range, the item registration unit 132 may determine whether the initial entrance fee and the contract price setup range are proper taking account into the open market selling price of the item.

In addition, the item registration unit 132 calculates a maximum payable bid price, which can be paid as a sales payment for the item, based on the open market selling price and the auction quantity of the item and registers the maximum payable bid price in the auction condition DB 115.

The item registration unit 132 also refers to the auction condition DB 115 for the auction duration of an item and when an auction start time is encountered, posts the item and auction conditions (e.g., an open market selling price, auction quantity, an initial entrance fee, an entrance fee type, a contract price setup range, and a contract price setup unit) for the item to a web site of the random drawing auction system 100.

The bid qualification determiner 133 receives from the client manager 131, identification information (e.g., a buyer ID) of a buyer accessing the random drawing auction system 100 through the Internet 400 using a purchase application terminal 300 to buy an auctioned item, and checks all information regarding the buyer accessing the random drawing auction system 100 with reference to the client DB 111 and the buyer's bid history DB 117.

When a buyer requests a permission to participate in a bid for an item (e.g., item#n) posted by the item registration unit 132, the bid qualification determiner 133 determines whether the buyer is qualified to bid for the item with reference to the buyer's bid history stored in the buyer's bid history DB 117.

In detail, when the buyer's bid history includes a total bid count for the item or a total bid count during a predetermined period of time, the bid qualification determiner 133 checks whether the total bid count exceeds a maximum available bid count, that is, the maximum number of bids permitted to the buyer for an item or during the predetermined period of time, and determines whether the buyer is qualified according to the result of the check. Alternatively, when the buyer's bid history includes a total bid amount for the item or during a predetermined period of time, the bid qualification determiner 133 checks whether the total bid amount exceeds a maximum available bid amount, that is, the maximum amount of bid price permitted to the buyer for an item or during the predetermined period of time, and determines whether the buyer is qualified according to the result of the check.

When the total bid count exceeds the maximum available bid count or the total bid amount exceeds the maximum available bid amount, the bid qualification determiner 133 determines that the buyer is unqualified, notifies the buyer of disapproval, and restricts the bid of the buyer.

When the buyer is determined as being qualified for a bid by the bid qualification determiner 133, the bid execution unit 134 requests the buyer to pay an initial entrance fee of the item, requests the buyer to set a tender price for the item after collecting the initial entrance fee from the buyer, and registers the tender price in the item's bid details DB 119.

When the buyer, i.e., the bidder finishes the bid for the item, the bid execution unit 134 adds an item management number, a bid number, a bid date, etc., regarding the bid for the item made by the buyer to the buyer's bid history stored in the buyer's bid history DB 117 and updates the total bid count or the total bid amount in the buyer's bid history.

In addition, when the buyer finishes the bid for the item, the bid execution unit 134 adds a bidder ID, a bid date/time, and a tender price regarding the bid for the item made by the buyer to the item's bid details stored in the item's bid details DB 119 and updates an accumulated entrance fee and an accumulated number of bidders in the item's bid details.

The bid terminator 135 refers to the item's bid details DB 119 for the accumulated entrance fee of the item for which bidding is executed by the bid execution unit 134, refers to the auction condition DB 115 for auction conditions for the item, and determines whether to terminate the bid for the item.

If an entrance fee type included in the auction conditions for the item is a fixed type, the bid terminator 135 terminates the bid for the item when the accumulated entrance fee of the item reaches a maximum payable bid price set for the item or when an auction end time of the item is encountered even though the accumulated entrance fee of the item does not reach the maximum payable bid price.

If the entrance fee type included in the auction conditions for the item is a variable type, the bid terminator 135 terminates the bid for the item when the auction end time is encountered regardless of the accumulated entrance fee.

When the bid for the item is terminated by the bid terminator 135, the entrance fee refund processor 136 determines whether to refund an entrance fee based on the entrance fee type, the accumulated entrance fee, the accumulated number of bidders (buyers), and the maximum payable bid price and refunds a certain amount of money to each of bidders that have made a bid for the item.

In detail, when the entrance fee type is the variable type, the entrance fee refund processor 136 determines whether the accumulated entrance fee obtained after the termination of the bid exceeds the maximum payable bid price. If it is determined that the accumulated entrance fee exceeds the maximum payable bid price, the entrance fee refund processor 136 refunds every bidder for the item the amount of money calculated by dividing the surplus of the accumulated entrance fee by the accumulated number of bidders for the item. Consequently, every bidder is refunded some of the initial entrance fee, and therefore, every bidder could bid for the item with an entrance fee less than the prepaid initial entrance fee. However, if the accumulated entrance fee does not exceed the maximum payable bid price, the entrance fee refund processor 136 does not perform the refund operation.

When the entrance fee type is the fixed type, since the accumulated entrance fee does not exceed the maximum payable bid price, the entrance fee refund processor 136 does not perform the refund operation. When the random drawing auction system 100 supports only the fixed entrance fee type, the random drawing auction system 100 may not include the entrance fee refund processor 136.

The entrance fee refund processor 136 may manage an item whose entrance fee has been partially refunded using a separate DB (not shown). In this case, the DB may store information such as an item management number, an initial entrance fee, a final entrance fee (i.e., varied entrance fee), a refund amount, a refund date, and a refunded buyer with respect to the item.

When the bid for the item is terminated by the bid terminator 135, the successful bidder selector 137 calculates a reference contract price for the item using a minimum contract price and a maximum contract price obtained from a contract price setup range set for the item and a random number induced by a random probability function. For example, when the minimum contract price is 1,000 won, the maximum contract price is 20,000, and the random number is 0.03, the reference contract price may be [1,000+(20,000−1,000)×0.03=1,570]. Here, the random probability function induces an arbitrary number between 0 and 1 as the random number.

Thereafter, the successful bidder selector 137 compares the reference contract price with tender prices set by respective bidders bidding for the item and selects as a successful bidder, a bidder setting a tender price closest to the reference contract price or a bidder setting a tender price close to the reference contract price in a predetermined sequence (e.g., in a third place or a fifth place).

Here, to select a bidder offering a tender price closest to the reference contract price, a method using an absolute value of a difference between the reference contract price and a tender price (hereinafter, referred to as an “absolute-value scheme”), a method of selecting a tender price closest to the standard price from among tender prices that are at least the reference contract price (hereinafter, referred to as a “low-cut scheme”), or a method of selecting a tender price closest to the standard price from among tender prices that do not exceed the reference contract price (hereinafter, referred to as a “high-cut scheme”) may be used.

When using the absolute-value scheme, the successful bidder selector 137 calculates an absolute value of a difference between the reference contract price and each of all tender prices, detects a minimum absolute value, and selects as a successful bidder a bidder that has set a tender price giving the minimum absolute value. When there are at least two bidders set the tender price giving the minimum absolute value and the auction quantity of the item is 1, the successful bidder selector 137 may check a bid sequence of each of the at least two bidders, referring to the item's bid details DB 119 and select a bidder having an earliest bid sequence from among the at least two bidders as a successful bidder. When the auction quantity of the item is plural, the successful bidder selector 137 sequentially detects minimum absolute values as many as the auction quantity and selects bidders having set tender prices giving the detected minimum absolute values as successful bidders.

When using the low-cut scheme, the successful bidder selector 137 selects a tender price closest to the reference contract price from among tender prices that are at least the reference contract price and selects a bidder having set the selected tender price as a successful bidder.

When using the high-cut scheme, the successful bidder selector 137 selects a tender price closest to the reference contract price from among tender prices that do not exceed the reference contract price and selects a bidder having set the selected tender price as a successful bidder.

The delivery/payment processor 138 requests the successful bidder selected by the successful bidder selector 137 to pay the tender price set by the successful bidder and, upon collecting the tender price from the successful bidder, requests the seller of the item to deliver the item to the successful bidder.

In addition, when the delivery of the item is completed, the delivery/payment processor 138 gives, as a sales payment, the amount of money that does not exceed the maximum payable bid price in the accumulated entrance fee and some of the tender price paid by the successful bidder to the seller of the item.

Thereafter, the delivery/payment processor 138 stores information on the results of the delivery and the payment in the delivery/payment details DB 121.

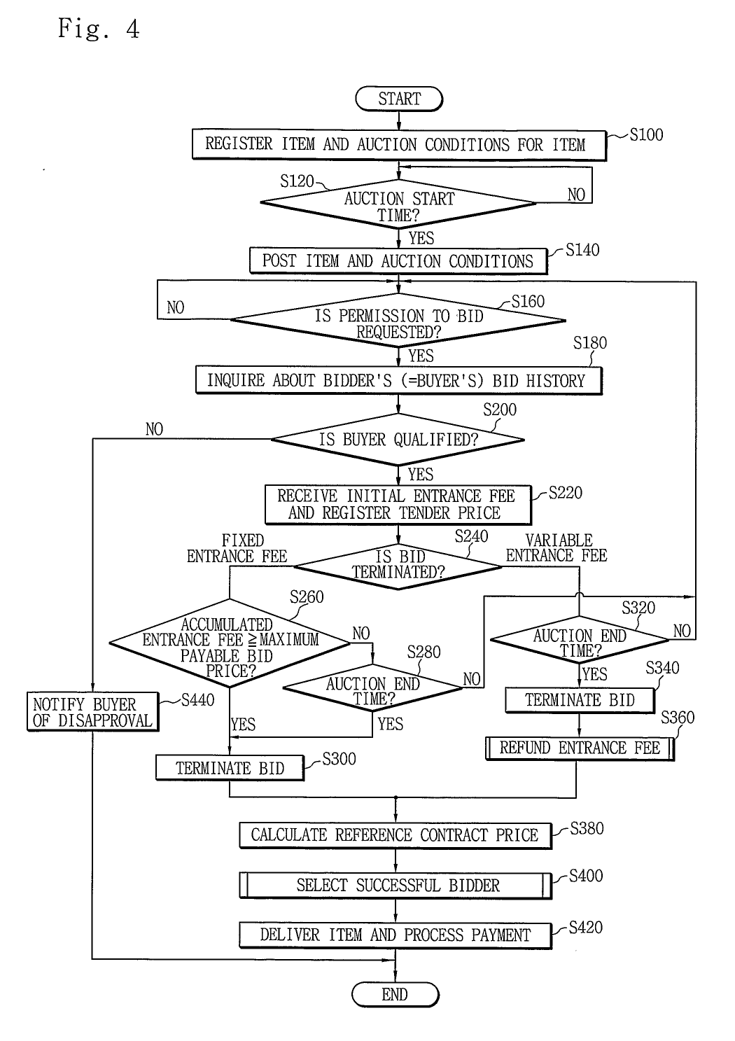

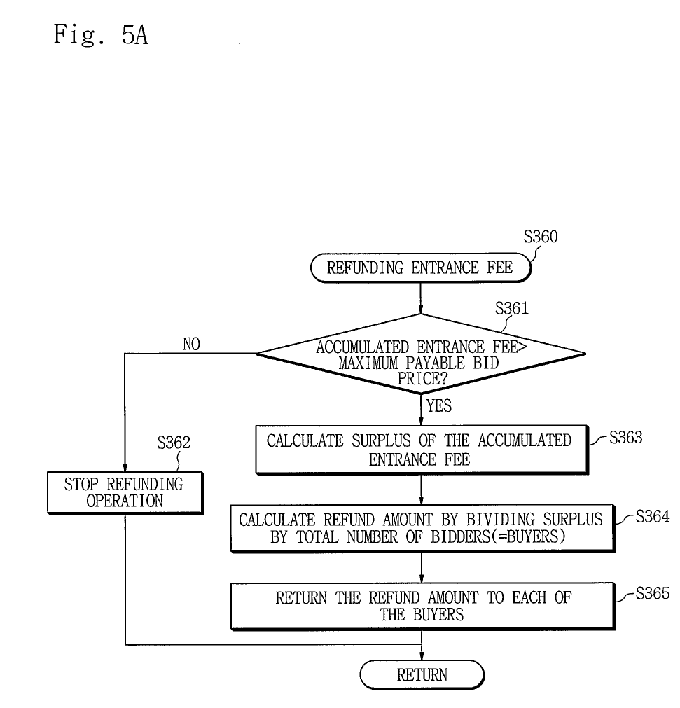

FIG. 4 is a flowchart of a random drawing auction method based on an entrance fee profit model according to an embodiment of the present invention. Referring to FIG. 4, in operation S100, basic information of an item and auction conditions for the item are received through Internet from a seller wishing to auction the item and registered in a DB, using a random drawing auction system according to an embodiment of the present invention. Here, the random drawing auction system calculates a maximum payable bid price for the item based on an open market selling price and auction quantity of the item which are included in the auction conditions for the item and registers the maximum payable bid price in the DB.

When the random drawing auction system determines based on auction duration of the item that an auction start time is encountered in operation S120, it posts the item and the auction conditions for the item to a web site in operation S140.

Thereafter, when a buyer accesses the random drawing auction system through the Internet and requests permission to bid for the item in operation S160, the random drawing auction system inquires about the buyer's bid history in operation S180 and determines whether the buyer is qualified to bid for the item in operation S200. When it is determined that the buyer is unqualified, the unqualified buyer is notified of disapproval in operation S440. Operation S200 has been described above when the operations of the bid qualification determiner 133 were described with reference to FIG. 2, and thus, a detailed description thereof will be omitted.

When it is determined that the buyer is qualified in operation S200, the random drawing auction system requests the buyer to pay an initial entrance fee for the item, requests the buyer to set a tender price for the item after collects the initial entrance fee from the buyer, and registers the tender price set by the buyer, i.e., bidder, in operation S220.

In operation S240, the random drawing auction system performs operation to determine whether to terminate a bid for the item.

If an entrance fee type of the item is a fixed type, when it is determined that an accumulated entrance fee of the item reaches the maximum payable bid price in operation S260 or when it is determined that an auction end time of the item is encountered in operation S280 even though the accumulated entrance fee of the item does not reach the maximum payable bid price, the random drawing auction system terminates the bid for the item in operation S300. When it is determined that the accumulated entrance fee of the item does not reach the maximum payable bid price in operation S260 and when it is determined that the auction end time of the item is not encountered in operation S280, the random drawing auction system returns to operation S160 to continue the bid.

If the entrance fee type of the item is a variable type, when it is determined that the auction end time of the item is encountered in operation S320, the random drawing auction system terminates the bid for the item in operation S340. When it is determined that the auction end time is not encounter in operation S320, the random drawing auction system returns to step S160 to continue the bid.

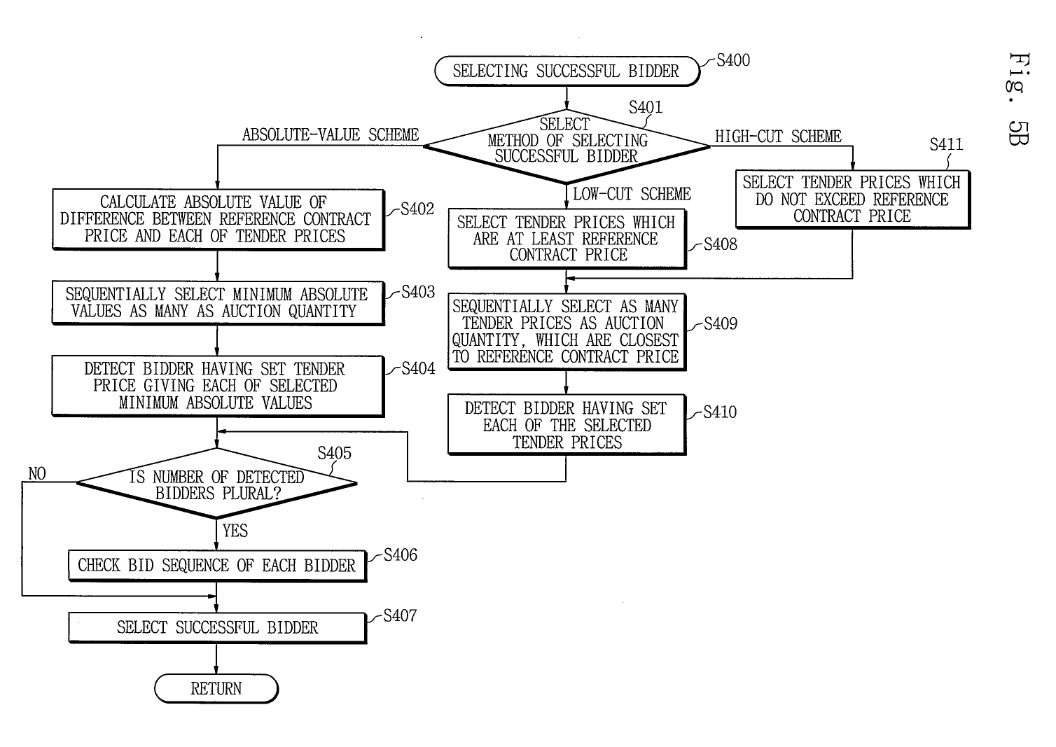

After terminating the bid in operation S340, the random drawing auction system recognizes that the entrance fee type of the item is the variable type, determines whether to refund an entrance fee based on the accumulated entrance fee of the item and the maximum payable bid price of the item, and refunds a certain amount of money to each of all bidders in operation S360, which will be described in detail with reference to FIG. 5A. As described above, the random drawing auction system according to the present invention performs the refund operation only when the entrance fee type is the variable type.

After operation S300 or S360, the random drawing auction system calculates a reference contract price for the item using a minimum contract price and a maximum contract price obtained from a contract price setup range set for the item and a random number induced by a random probability function in operation S380.

Thereafter, in operation S400, the random drawing auction system compares tender prices set by bidders for the item with the reference contract price calculated in operation S380 and selects as a successful bidder a bidder having set a tender price that is closest to the reference contract price or close in a predetermined sequence to the reference contract price. Selecting as a successful bidder a bidder having set a tender price closest to the reference contract price will be described with reference to FIG. 5B.

In operation S420, the random drawing auction system requests the successful bidder to pay the tender price set by the successful bidder, requests the seller of the item to deliver the item to the successful bidder after collecting the tender price from the successful bidder, and gives the seller a sales payment for the item after the delivery of the item is completed. Here, the sales payment given to the seller has been described when the operations of the delivery/payment processor 138 were described with reference to FIG. 2, and thus a detailed description thereof will be omitted. When the entrance fee type is the variable type, the random drawing auction system may perform operation S360 after performing operation S420.

FIG. 5A is a flowchart of operation S360 of refunding the entrance fee in the random drawing auction method shown in FIG. 4. Referring to FIG. 5A, the random drawing auction system recognizes that the entrance fee type of the item is the variable type after terminating the bid and determines whether the accumulated entrance fee of the item exceeds the maximum payable bid price in operation S361.

When it is determined that the accumulated entrance fee of the item does not exceed the maximum payable bid price in operation S361, the random drawing auction system stops the refund operation and does not refund to the bidders in operation S3362.

When it is determined that the accumulated entrance fee of the item exceeds the maximum payable bid price in operation S361, the random drawing auction system calculates the surplus, i.e., the difference between the accumulated entrance fee and the maximum payable bid price in operation S363.

Next, the random drawing auction system calculates a refund amount by dividing the surplus by a total number of bidders (i.e., buyers) that have bidden for the item in operation S364 and returns the refund amount to each of the buyers having bidden for the item in operation S365. For example, when the maximum payable bid price is 100,000 won, the initial entrance fee of the item is 500 won, and the total number of bidders having bidden for the item is 1000, the accumulated entrance fee of the item will be [500×1000=500,000] after the bid is terminated. Here, the accumulated entrance fee exceeds the maximum payable bid price, and the surplus is 400,000 won, which is divided by the total number of bidders, 1000. As a result, the refund amount is 400 won. Accordingly, each of the bidders is refunded 400 won. Since the initial entrance fee of the item is partially refunded, the initial entrance fee is changed from 500 won to 100 won consequently.

FIG. 5B is a flowchart of operation S400 of selecting the successful bidder in the random drawing auction method shown in FIG. 4. In particular, FIG. 5B illustrates operations for selecting as the successful bidder a bidder having set a tender price closest to the reference contract price using the absolute-value scheme, the low-cut scheme, and the high-cut scheme.

When a random drawing auction system according to an embodiment of the present invention selects the absolute-value scheme as a method of selecting the successful bidder in operation S401, it calculates an absolute value of a difference between the reference contract price calculated in operation S380 and each of tender prices set by all of the bidders for the item in operation S402.

In operation S403, as many minimum absolute values as the auction quantity of the item are sequentially selected from among the calculated absolute values. For example, when the auction quantity of the item is 2, two minimum absolute values are selected.

In operation S404, the random drawing auction system detects a bidder having set each of tender prices giving the absolute values selected in operation S403.

When it is determined that the number of bidders detected in operation S404 is plural in operation S405, the random drawing auction system checks a bid sequence of each of the detected bidders in operation S406 and selects a bidder having an earliest bid sequence as the successful bidder in operation S407.

Meanwhile, when the random drawing auction system selects the low-cut scheme in operation S401, it compares the reference contract price calculated in operation S380 with each of tender prices set by all of the bidders for the item and selects tender prices that are at least the reference contract price in operation S408.

In operation S409, as many tender prices closest to the reference contract price as the auction quantity of the item are sequentially selected from among the tender prices selected in operation S408.

In operation S410, the random drawing auction system detects a bidder having set each of the tender prices selected in operation S409. Thereafter, the random drawing auction system performs operations S405, S406, and S407.

When the random drawing auction system selects the high-cut scheme in operation S401, it compares the reference contract price calculated in operation S380 with each of tender prices set by all of the bidders for the item and selects tender prices that do not exceed the reference contract price in operation S411. Thereafter, the random drawing auction system performs operations S409, S410, S405, S406, and S407.

The above description just concerns embodiments of the present invention. The present invention is not restricted to the above embodiments, and various modifications can be made thereto within the scope defined by the attached claims. For example, the shape and structure of each member specified in the embodiments can be changed.

### INDUSTRIAL APPLICABILITY

According to the present invention, in an accumulated entrance fee of an item, the amount of money that does not exceed an open market selling price of the item is given to a seller of the item as a sales payment, unfair benefit of the seller occurring when the accumulated entrance fee greatly exceeding the open market selling price is promoted by the seller's foul manipulation can be prevented.

In addition, since a lucky bidder casually offering a tender price closest to a reference contract price, which is arbitrarily set for the item using a random probability function after a bid for the item is terminated, is selected as a successful bidder, competitively bidding in a speculative manner can be prevented. Moreover, since a seller can purchase at a low cost, the seller can enjoy buying an item.

The present invention also provides a distribution channel for expensive articles and articles fundamentally having a small number of potential buyers and a new distribution environment for usual articles. Since an accumulated entrance fee (that does not exceed the open market selling price of an item) and a tender price paid by a successful bidder for the item are given to a seller of the item as a sales payment, the seller is guaranteed an appropriate sales margin.

In addition, according to the present invention, it is possible to expand a sales market using an entrance fee based scheme employed by existing tender type auction, a sales payment given to a seller can be restricted to about an open market selling price, the limit of the price of an article and registrable items can be adjusted, and advantages of the tender type auction can be provided.

Moreover, in the present invention, a total bid count or a total bid amount granted to buyers for one item or during a predetermined period of time is restricted, thereby preventing the buyers from bidding recklessly or speculatively.

1. A random drawing auction system based on an entrance fee profit model, comprising:
a database unit storing auction condition information comprising an open market selling price, auction quantity, auction duration, an initial entrance fee and an entrance fee type of an item auctioned through Internet, bid history information of a buyer wishing to purchase the item through the Internet, and bid details information of the item;
an item registration unit allowing a seller to register auction condition information of an item or directly register the auction condition information and posting the item and the auction condition information to a web site when an auction start time of the registered item is encountered;
a bid qualification determiner determining whether a buyer is qualified for bidding for an item based on the buyer's bid history information in response to the buyer's request for permission to bid for the item;
a bid execution unit requesting the buyer to pay an initial entrance fee of an item when a buyer is determined as being qualified for bidding for the item, collecting an initial entrance fee of the item from the buyer, requesting the buyer to set a tender price for the item, and inputting the tender price;
a bid terminator determining whether to terminate a bid for an item based on at least one among auction duration of the item, for which the bid is being executed by the bid execution unit, and an accumulated entrance fee resulting from the bid of each of buyers for the item;
a successful bidder selector calculating a reference contract price using a minimum contract price and a maximum contract price of an item and a random number induced by a random probability function after a bid for the item is terminated, comparing the reference contract price with a tender price set by each of buyers, and selecting as a successful bidder a buyer that has set a tender price closest to the reference contract price or close in a predetermined sequence to the reference contract price; and
a delivery/payment processor collecting a tender price set by a buyer selected as a successful bidder, performing a process to deliver an item to the successful bidder, and giving a sales payment to a seller of the item.

2. The random drawing auction system of claim 1, wherein the item registration unit calculates a maximum payable bid price, which can be paid as a sale payment for the item, using an open market selling price and auction quantity of the item.

3. The random drawing auction system of claim 2, wherein the auction condition information further comprises a contract price setup range for the item, the buyer's bid history information comprises at least one among a total bid count and a total bid amount of a buyer obtained for an item or during a predetermined period of time, and the bid details information of the item comprises information on a bidder bidding for the item and an accumulated entrance tee resulting from bidders' bidding for the item.

4. The random drawing auction system of claim 3, wherein the bid qualification determiner determines that the buyer is unqualified for bidding for the item when a total bid count or a total bid amount of the buyer obtained for the item or during a predetermined period of time exceeds a predetermined maximum available bid count or a predetermined maximum available bid amount, respectively.

5. The random drawing auction system of claim 3, wherein if an entrance fee type of an item is a fixed type where an initial entrance fee is set as a final entrance fee, the bid terminator terminates a bid for the item when an accumulated entrance fee of the item reaches a maximum payable bid price set for the item or when an auction end time of the item is encountered even though the accumulated entrance fee of the item does not reach the maximum payable bid price.

6. The random drawing auction system of claim 3, wherein if an entrance fee type of an item is a variable type where an initial entrance fee varies with an accumulated entrance fee of the item and a total number of bidders for the item which are obtained after the bid for the item is terminated, the bid terminator terminates the bid for the item when an auction end time of the item based on the auction duration of the item is encountered.

7. The random drawing auction system of claim 6, further comprising an entrance fee refund processor when the entrance fee type of the item is the variable type, the entrance fee refund processor comparing an accumulated entrance fee of the item with a maximum payable bid price of the item after the bid for the item is terminated, refunding each of bidders having bidden for the item an amount of money obtained by dividing a surplus of the accumulated entrance fee by a total number of the bidders when the accumulated entrance fee exceeds the maximum payable bid price, but otherwise not refunding.

8. The random drawing auction system of claim 5, wherein the delivery/payment processor gives a seller of the item an amount of money not exceeding the maximum payable bid price in the accumulated entrance fee of the item and a tender price collected from a successful bidder for the item as a sales payment for the item.

9. The random drawing auction system of claim 1, wherein the successful bidder selector calculates an absolute value of a difference between a reference contract price of an item and each of tender prices, selects as a successful bidder a bidder having set a tender price giving a minimum absolute value, or the successful bidder selector selects as the successful bidder a bidder having set a tender price closest to the reference contract price or close in a predetermined sequence to the reference contract price among tender prices that are at least or do not exceed the reference contract price.

10. A random drawing auction method based on an entrance fee profit model, comprising the operations of:
(a) receiving auction condition information comprising an open market selling price, auction quantity, auction duration, an initial entrance fee and an entrance fee type of an item from a seller wishing to sell the item through Internet, registering the auction condition information in a database, and posting the item and the auction condition information when an auction start time of the item is encountered;
(b) determining whether a buyer accessing through the Internet is qualified for bidding based on bid history information of the buyer in response to the buyer's request for permission to bid for the item, collecting an entrance fee of the item from the buyer when it is determined that the buyer is qualified, and requesting the buyer to set and input a tender price of the item;
(c) determining whether to terminate the bid for the item based on at least one among the auction duration of the item and an accumulated entrance fee resulting from the bid of each of buyers for the item;
(d) calculating a reference contract price using a minimum contract price and a maximum contract price of the item and a random number induced by a random probability function after the bid for the item is terminated, comparing the reference contract price with a tender price set by each of the buyers, and selecting as a successful bidder a buyer that has set a tender price closest to the reference contract price or close in a predetermined sequence to the reference contract price; and
(e) collecting the tender price set by the buyer selected as the successful bidder, performing a process to deliver the item to the successful bidder, and giving a sales payment to the seller of the item.

11. The random drawing auction method of claim 10, wherein operation (a) comprises calculating a maximum payable bid price, which can be paid
as the sale payment for the item, using the open market selling price and the auction quantity of the item.

12. The random drawing auction method of claim 11, wherein operation (c) comprises, if an entrance fee type of the item is a fixed type, terminating the bid for the item when the accumulated entrance fee of the item reaches the maximum payable bid price or when an auction end time of the item is encountered even though the accumulated entrance fee of the item does not reach the maximum payable bid price.

13. The random drawing auction method of claim 11, wherein operation (c) comprises, if an entrance fee type of the item is a variable type, terminating the bid for the item when an auction end time of the item based on the auction duration of the item is encountered.

14. The random drawing auction method of claim 13, further comprising, between operations (c) and (d), recognizing that the entrance fee type of the item is the variable type when the bid for the item is terminated, comparing the accumulated entrance fee with the maximum payable bid price, determining whether to refund according to the result of the comparison, and refunding some of the initial entrance fee of the item to each of the buyers having bidden for the item.

15. The random drawing auction method of claim 11, wherein operation (e) comprises giving the seller of the item an amount of money not exceeding the maximum payable bid price in the accumulated entrance fee of the item and the tender price collected from the successful bidder for the item as the sales payment for the item.

16. The random drawing auction system of claim 7, wherein the delivery/payment processor gives a seller of the item an amount of money not exceeding the maximum payable bid price in the accumulated entrance fee of the item and a tender price collected from a successful bidder for the item as a sales payment for the item.

17. The random drawing auction method of claim 14, wherein operation (e) comprises giving the seller of the item an amount of money not exceeding the maximum payable bid price in the accumulated entrance fee of the item and the tender price collected from the successful bidder for the item as the sales payment for the item.
